(19) United States
(12) Patent Application Publication
(10) Pub. No.: US 2024/0316640 A1
(43) Pub. Date: Sep. 26, 2024

(54) IMPROVED METHOD FOR PRODUCING A COMPONENT BY MEANS OF ADDITIVE MANUFACTURING

(71) Applicant: RWTH Aachen, Aachen (DE)

(72) Inventors: Lukas Oster, Aachen (DE); Samuel Mann, Aachen (DE); Uwe Reisgen, Aachen (DE)

(21) Appl. No.: 18/578,949

(22) PCT Filed: Jul. 27, 2022
(86) PCT No.: PCT/EP2022/071061

§ 371 Date: Jan. 12, 2024

(30) Foreign Application Priority Data
Jul. 28, 2021 (DE) 10 2021 208 164.9

(51) Int. Cl. B22F 10/22; B22F 12/20; B23K 9/04; B33Y 10/00; C21D 9/50

(52) U.S. Cl. CPC B22F 10/22; B22F 12/20; B23K 9/042; C21D 9/505; B33Y 10/00; C21D 2211/008

(57) ABSTRACT

According to the invention, a method is provided for additively manufacturing a component, in particular a metallic component, said method having the steps of: ⋅ providing at least one substrate (I), in particular a substrate plate, the substrate being formed from one or more metallic substrate materials which has a martensite start temperature (Ms) below 140° C., the martensite start temperature (Ms) being below the manufacturing temperature (Tp); ⋅ building the component on a building surface (5) of the substrate (I) by layered application of at least one material at a manufacturing temperature (Tp) to form a component-substrate composite (7) over a boundary surface (6); ⋅ after building of the component (3) is complete, cooling at least the substrate (I) in the component-substrate composite (7) to a temperature below the martensite start temperature (Ms), wherein, as a result of martensitic transformation and the associated volume expansion of the metallic substrate material, a transformation stress is induced in the substrate (I), at least in the boundary surface (6) to the component (3); and ⋅ separating the component (3) from the substrate (I). The invention further relates to a substrate (I) for use in such a method.

The invention relates to an improved method for manufacturing a component, in particular a metallic component, by means of additive manufacturing and a metallic substrate for use in such a method.

### BACKGROUND

Additive manufacturing, which is usually also referred to as 3D printing or generative manufacturing, is becoming increasingly important in the industry. These manufacturing methods are used in particular in the prototype construction, in the case of components with a high degree of individualization or components with a complicated geometry. However, the extent to which additive manufacturing is used is also increasing in the manufacturing of end products. These methods are used in particular in the aerospace industry, the medical field (prosthetics), the automotive sector and the tool making because demands, which promote the generative manufacturing, are made on the components in these sectors.

In the case of additive manufacturing methods, a component is created by means of layered application of material. It is a special feature and large advantage of such generative manufacturing methods that the manufacturing process takes place in a tool-free manner and without molds directly on the basis of computer-generated templates, for example 3D CAD data. In contrast to the conventional manufacturing methods, this increases the flexibility in the manufacturing. A rapid manufacturing of prototypes (rapid prototyping), of end products (rapid manufacturing) and of tools and molds (rapid tooling) is possible. A wide range of different materials, substances, can be processed, such as, for example, plastics, ceramics and metals, by means of different additive manufacturing methods.

It is a further advantage of the additive manufacturing that the manufacturing process usually runs in an automated manner. Only the preparation of the machine and the removal of the component, the separation from a used substrate, for example a building plate, as well as a possible post-treatment, usually have to take place manually. In particular the separation of the component from the substrate may be highly complex thereby.

In the case of the powder bed-based manufacturing methods, a powdery substance is applied in a thin layer onto a work surface, for example a substrate plate. The material is melted or sintered with pinpoint accuracy according to a computer-supported template by means of an energy beam, in particular a laser beam or an electron beam. During the resolidification, the melted or sintered material, respectively, forms a fixed contour, which is joined to form a workpiece with contours produced beforehand and/or subsequently in the same way. In particular molded bodies, which have a partially highly complex three-dimensional structure, can be constructed in this way. Powder-based generative manufacturing methods are, for example, electron beam melting (EBM), selective laser beam melting (SLM) or selective laser sintering (SLS).

In the case of the powder spraying method for the additive manufacturing of components, a powdery substance is applied to a substrate by means of a carrier gas and is melted by means of an energy beam. A plasma beam (plasma transferred arc welding) or a laser beam (laser metal deposition, LMD) is generally used as energy beam thereby.

Powder-based generative manufacturing methods on metal base are used to protect against environmental influences, for example oxidation, mostly under protective gas or in a vacuum. After ending the manufacturing, the component has to cool down. If a protective gas is used, the latter can be used to support the process of the cool-down; in the case of additive manufacturing methods, which are performed under vacuum, the manufactured component has to be cooled and the previously evacuated blast chamber has to be flooded with a gas to ambient pressure. The blast chamber can be flooded, for example, with an inert gas, for example helium, which can simultaneously be used for a cool-down of the component to ambient temperature.

Wire-based additive manufacturing methods have furthermore established themselves. In the case of this method, a metal wire is melted by means of an energy source and is used for the layered construction of the component. The properties of the manufactured component are thereby determined essentially by the selection of the metal or of the metal alloy of the used wire, respectively. Laser beams, electron beams or electric arcs (wire arc additive manufacturing, WAAM) can be used as energy source here.

The so-called wire arc additive manufacturing (WAAM) uses arc welding for the layered construction of the component. Continuously conveyed wire-shaped welding filler material and substrate plates are melted thereby with the help of an electric arc as heat source. In the effective region of the arc (process zone), the welding filler material (mostly in drop shape) transitions into the weld pool of the substrate plate and forms a welding bead after solidifying. By moving the welding torch and the wire, an arbitrary contour material can be applied along a specified path. Large-format metal components can thus also be created quickly, which can be machine-finished subsequently, for example by means of CNC milling. The welding process, usually metal protective gas welding, plasma welding or tungsten inert gas welding, is generally known and can be used for complex component geometries, for example in combination with a 5-axis control. All weldable wires, such as, for example, steel, aluminum, NE metals or Ti and Ti alloys can be used as materials for the component construction. Many wires, which have already been certified, are already available for the use as starting material in the WAAM now.

Technical substances on the base of iron, which are used in wire form in the additive manufacturing on metal base, for example, can be present in different crystal lattice modifications (phase) (polymorphy) as a function of the alloying elements thereof and of the prevailing temperature. These modification have different volumes, for example. During the cool-down and heat-up, a substance can therefore pass through different phase transformations and thus volume changes. The phase transformation austenite-martensite, which is associated with a volume increase, is of particular interest for the influencing of residual stresses, for example in the case of chrome-nickel alloyed steels. The substance solidifies austeniticially and, when reaching the martensite start temperature (Ms), begins with the martensitic phase transformation, which concludes when reaching the martensite finish temperature (Mf). This phase transformation takes place in conventional alloy systems at temperatures above 500° C., so that the volume change can be compensated by plastic deformation of the softened material.

So-called low transformation temperature (LTT) alloys are characterized in that a shift of the Ms temperature all the way to lower temperatures is attained by adapting the alloying elements, so that a compensation of the volume change is complicated by means of plastic deformation and a buildup of residual stresses occurs instead. Compressive stresses, which counteract the thermal shrinkage stresses (LTT effect), are induced by means of the volume change during the martensite transformation. This mechanism is already used during the joint welding in order to reduce the residual welding stresses. The Ms temperature is thereby set so that the transformation is concluded completely at room temperature and the maximum volume increase is attained. LTT alloys are equally used during the construction of components, for example also as additional material in electron beam or arc welding processes. The volume expansion, the so-called LTT effect, counteracts the volume shrinkage during the cool-down of the produced components at room temperature and thus effects a reduction of stress loads and distortion in the components.

The US 2019/01600 595 A1 describes the utilization of the above-described LTT effect in a method of the additive, near net shape manufacturing and Cr/Ni-rich material compositions for this with a low LTT temperature in the range of 150° C. to 300° C. It is thus utilized thereby that the martensitic volume expansion counteracts the occurring shrinkage stresses in the workpiece and a manufacturing, which is as close to contour as possible, can thus take place.

In the additive manufacturing of metallic components, the material for the construction is usually applied to a metallic substrate plate of the same type. The latter has to subsequently either be removed subtractively in a complex manner or it is integrated in the component. In the latter case, it usually has other mechanically technological properties than the applied material.

The DE 10 2019 115 770 A1 describes a carrier plate for the additive manufacturing, wherein the carrier plate is provided for the disposal after the manufacturing, but a cost reduction is to be attained in the method, by using a cheaper material, for example construction steel or cast iron, for the base substrate body of the carrier plate. A boundary surface (cooperation section) of a material, which can be fused well with the material for the workpiece in the additive manufacturing, is provided on this base body for establishing the type identity. The carrier plate has to nonetheless be removed and disposed of subtractively after the additive manufacturing. The increasingly important aspect of sustainability and resource-saving procedure is thus not sufficiently considered.

The US2018/0272609 A1, which describes a carrier structure, in particular a substrate plate for the additive manufacturing, as well as a method for the additive manufacturing in which it is used, takes a different approach. The carrier structure thereby mandatorily comprises a boundary surface layer, which is manufactured from a material, which has a higher deformation-embrittlement temperature than the material of the substrate body located therebelow, in order to selectively break the boundary surface layer and to separate an additively manufactured workpiece from the carrier structure via this predetermined breaking layer. The boundary surface layer has to also have a higher deformation-embrittlement transition temperature than the material of the workpiece. For this purpose, inclusions or embrittlement components are systematically provided in the material of the boundary surface layer, which can lead to the breakage of the boundary surface layer during the heating and subsequent cool-down. They can be, e.g., steels with high nitrogen content. Other, so-called “embrittlement constituents” disclosed in this document are oxygen, sulfur or phosphor.

### Object

Based on this, it is an object of the invention to provide an improved method for a sustainable and resource-saving additive manufacturing, which provides for a simplified separation of the created component from the substrate.

### BRIEF DESCRIPTION OF THE INVENTION

The object is solved by means of a method according to claim 1. Further advantageous embodiments are subject matter of the dependent claims, of the description and of the figures. Standards mentioned in the description are those in the respective version, which is valid on the filing date.

According to the invention, a method for the additive manufacturing of a component, in particular of a metallic component, is provided, having the steps of
providing at least one substrate, in particular a substrate plate, wherein the substrate is formed or will be formed from one or several metallic substrate materials, which has a martensite start temperature Ms of below 140° C. and the martensite start temperature Ms lies below the manufacturing temperature T_{F},
construction of the component on a construction surface of the substrate by layered application of at least one material at a manufacturing temperature T_{F} by forming a component-substrate composite via a boundary surface,
cooling down at least the substrate in the component-substrate composite after the complete construction of the component to a temperature below the martensite start temperature Ms, wherein, as a result of a martensite transformation and the associated volume expansion of the metallic substrate material, a transformation stress is induced in the substrate at least in the boundary surface to the component.
Separating the component from the substrate.

With the provision and use of a substrate according to the invention, in particular of a substrate plate, which, during the provided step of the cool-down of the substrate, undergoes a martensite transformation, the improved method according to the invention advantageously provides that the substrate can be released more easily and without larger effort from the applied structure, thus the constructed component, on the one hand, and can be reused with little treatment on the other hand. According to the invention, the martensitic phase transformation of the substrate material is created to be systematically controllable only after the complete application and construction of the component by cooling down the substrate. In contrast to the US 2018/0272609 A1, the volume expansion effect (LTT effect) is used thereby, which occurs during a martensitic transformation during the cool-down. Advantageously, the martensite transformation of the used substrate is reversible and the substrate can be reused after a slight processing.

In other words, the invention provides for a more easily releasable substrate and thus for a significantly simplified separation from the component, in that a martensitic transformation is provided or attained, respectively, in the substrate at temperatures significantly below the manufacturing temperature. The martensite transformation during the cool-down leads to a volume increase and thus induced compressive stresses at least in the region of the formed boundary surface between substrate and component.

The construction of the components according to the invention can generally take place by means of all known additive manufacturing methods. The components can thereby be constructed from all substance types, which are accessible for these methods, such as, for example, plastic, ceramic or metal. According to the invention, however, an additive manufacturing method for a component made of metal-based substances is preferred.

According to the invention, a substrate is preferably understood to be a substrate plate, which serves as basis for constructing the component by means of additive manufacturing. However, the substrate can furthermore also be a support structure of a different type and can have any other geometry for such a support structure for constructing a component by means of additive manufacturing, which, after construction of the component has taken place, is separated therefrom again.

In a preferred embodiment the substrate, thus for example a substrate plate, is produced from a metallic substrate material, for example a low transformation temperature (LTT) alloy, which, in contrast to conventional LTT alloys, has a martensite start temperature Ms of below 130° C., preferably of below 100° C., for example of below 70° C., 60° C., 50° C. or 40° C. The martensite start temperature Ms, which is to be set, is thereby set as a function of or in consideration of, respectively, the manufacturing temperature T_{F} of the material to be applied to the substrate, thus the substance for the component. By cooling down the substrate in a cooling medium, for example liquid nitrogen, the martensitic transformation is created in a systematically controllable manner only after the complete application of the component.

The manufacturing temperature T_{F} is alternatively also referred to as processing temperature. This is understood to be the temperature specified for the construction of the component. In other words, this is the temperature T_{F}, at which the substance is applied to the substrate in order to construct the first layer and then as next coat onto the already created component layer in the second and the following layers. In the welding-related context, the manufacturing temperature T_{F} is also referred to as an intermediate layer temperature. This is the temperature, to which the component (or the (partial) component-substrate composite, respectively) is allowed to cool down when constructing and applying the substance before the next layer of the substance is applied.

In another preferred embodiment of the method it is or will be formed from a substrate material, which has a martensite finish temperature Mf between 0° C. and −190° C., preferably between −50° C. und −150° C. In the case of the martensite finish temperature Mf, the martensite transformation of the substrate material is concluded and the largest volume expansion is reached. In contrast thereto, an attempt is made for the components to set up the martensite finish temperature Mf to be higher, as close as possible to the room temperature, thus approx. 20° C., in order to use the volume expansion to reduce shrinkage stresses, as described, for example, in the US 2019/01600 595 A, and to avoid or to reduce distortion induced thereby in the component.

According to the invention, the provision of the substrate, for example a substrate plate or another support structure, which, after the additive construction of the component, which took place thereafter, is to be separated therefrom again, can preferably likewise take place by means of additive manufacturing methods. It is also included according to the invention, however, when the substrate is produced from a suitable metallic material, for example by casting or forging.

In a preferred embodiment of the method according to the invention, the provision of the substrate comprises a metal wire-based additive manufacturing by means of laser beams, electron beams or arcs. The provision of the substrate can preferably comprise a manufacturing by means of wire arc additive manufacturing (WAAM). According to the invention, this is understood in particular as an arc welding method according to DIN EN ISO 4063 by exclusively using wire-shaped welding filler material. Gas metal arc welding (GMAW) or also tungsten inert gas welding (TIG) or plasma welding with cold wire feed can be used for the wire-based additive manufacturing of the substrate by means of WAAM. In the case of the TIG welding, the melting of an externally supplied welding wire takes place via an arc, which is created between a non-consumable tungsten electrode and the component to be constructed, here the substrate. During the GMAW welding, a consumable electrode is used, which simultaneously also serves as welding filler material. Both methods are usually carried out by using a protective gas in order to prevent an oxidation of the weld pool in the process zone. The advantage of the WAAM method is that very large components can generally also be constructed economically within a relatively short time. The material savings compared to subtractive methods is also advantageous. A GMAW welding process is preferably used for the provision of the substrate. Advantageously, these methods can be automated easily. This is important in particular for an industrial series production.

In a further preferred embodiment, the provision of the substrate can take place by means of wire arc additive manufacturing with multi-wire feed. Several welding filler materials (welding wires) are thereby simultaneously conveyed into the process zone, are melted and mixed together. According to the invention, welding filler materials of identical or different chemical composition can be used thereby. If the used welding filler materials have a different chemical composition, the actual desired alloy for the component, in this case the substrate according to the invention, is created by means of the mixing in the process zone. The optimal setting and adaptation of the substrate material manufactured in this way, in particular in situ, to the desired process parameters, such as, for example, the martensite start temperature, can be attained thereby.

In a preferred embodiment of the method, the cool-down of the substrate in the component-substrate composite can take place by immersion in a cooling medium. The cool-down of the method according to the invention takes place after conclusion of the construction of the component and is to be distinguished from only allowing a cool-down from the manufacturing temperature T_{F} to room temperature (ambient temperature). The substrate can be cooled down, for example, to a temperature below the room temperature, preferably below 0° C. or below −20° C. According to the invention, room temperature is understood to be a temperature of approx. 20° C. The martensite transformation in the substrate and the maximum volume expansion is induced by means of the cool-down. The cool-down according to the invention can take place, for example, by quenching by means of immersion in liquid nitrogen as cooling medium. Essentially only the substrate can thereby optionally be introduced into the cooling medium or the entire component-substrate composite during the immersion.

In a different preferred embodiment, the cool-down of the substrate in the component-substrate composite can take place in several cool-down/heat-up cycles. After the desired holding time in the cooling medium, the substrate can thereby optionally heat up the substrate-component composite to a higher temperature again, for example room temperature, in order to then cool them down again by means of the cooling medium, thus immerse, for example, in liquid nitrogen as cooling medium.

In a further embodiment of the method according to the invention, a separation of the component from the substrate can already take place at least partially with the cool-down. According to the invention, the separation of the substrate from the component can thus already take place partially or completely. After the separation, the component can be supplied to common post-processing steps, such as, for example, a heat treatment for tempering the substance or a grinding or milling. According to the invention, the substrate can advantageously be reused, optionally after a treatment, and can be used in an additive manufacturing of a component. This provides for significant cost and material savings, especially in industrially used methods.

In one embodiment of the method, the cool-down can advantageously already effect the complete separation of the component-substrate composite, so that cool-down and separation take place simultaneously. A self-releasing substrate is advantageously provided thereby and a separate separation step is not required in this embodiment of the method. This represents a further simplification of the method.

In a further preferred embodiment, the substrate can be used in a method for the additive manufacturing again after the separation and a treatment. The treatment can take place, for example, by means of superficial grinding, milling or a heat treatment.

The invention furthermore relates to a substrate for use in a method as described above in different forms and embodiments. The substrate according to the invention is formed of a metallic material, which undergoes a martensitic phase transformation and preferably has a martensite start temperature of below 140° C., for example below 130° C. or below 100° C., for example below 70° C. particularly preferably of below 60° C. The substrate can have, for example, a martensite start temperature Ms of approx. 55° C., 50° C., 40° C., 30° C. or 20° C. or of below 20° C., for example 0° C.

In another design, the substrate according to the invention is formed from a metallic material, which undergoes a martensitic phase transformation and preferably has a martensite finish temperature Mf between 0° C. and −190° C., preferably between −50° C. and −150° C.

In a preferred embodiment, the metallic substrate material is a low transformation temperature (LTT) alloy. This can be, for example, an alloy on the basis of Cr—Ni or on the basis of Mn. The chemical composition is to thereby be selected so that the desired martensite transformation temperature is set. For the alloy system iron-chrome-nickel, a respective chrome and nickel content of 16.5 m % can be set to obtain a martensite start temperature of 0° C. In the alloy system iron-manganese, a manganese content of 17 m % can be set for the same martensite start temperature. An additional reduction of the martensite start temperature can be effected by means of further alloying elements (in particular carbon), so that the contents of the main alloying elements (for example Ni, Cr or Mn) have to be smaller in technical alloys in order to obtain the desired martensite start temperature Ms. A technical alloy with 0.058% of C, 1.53% of Mn and 0.165% of Mo would therefore require a chrome and nickel content of 14.1% each for an Ms temperature of approx. 0° C.

An estimation of the required chemical composition can take place via formulas for calculating the martensite start temperature, for example the formula according to Steven and Haynes (W. Steven and A. G. Haynes, “The Temperature of Formation of Martensite and Bainite in Low-Alloy Steels,” Journal of the Iron and Steel Institute, Vol. 183, No. 8, 1956, pp. 349-359).

In another embodiment, the substrate according to the invention is formed from at least two different metallic substrate materials.

In a further preferred embodiment, the substrate is formed from at least two layers of different metallic substrate materials, which are arranged one on top of the other essentially parallel to the construction surface, whereby the substrate material of the layer comprises the construction surface (top side) or which is arranged closer to the construction surface, in each case has a higher martensite start temperature Ms than the substrate material of the layer arranged therebelow. If the substrate is a substrate plate, which is designed to be flat, for example a first layer can comprise the construction surface, whereby this layer has a martensite start temperature of, for example, Ms of 20° C. and the layer arranged therebelow, which is further away from the construction surface, has a martensite start temperature Ms of >>0° C. In such an embodiment, which is also referred to as multi-material substrate plate, a preferred direction is provided to the deformation effect during the cool-down, which even further simplifies the separation from the constructed component.

In another embodiment of the substrate according to the invention, brittle phases are formed in the substrate material in the construction surface. The local provision of such brittle phases, in particular in the region of boundary surfaces, can advantageously be used to further simplify the separation from a subsequently applied component because they can have an inferior connection to the constructed component. Such brittle phases can be, for example, intermetallic phases, for example iron aluminides.

### DETAILED DESCRIPTION OF THE INVENTION

According to the invention, the provision of the substrate plate can take place, for example, by means of a production via additive manufacturing methods, preferably by means of metal wire-based additive manufacturing by means of laser beams, electron beams or arcs. In a particularly preferred embodiment, this is a wire arc additive manufacturing (WAAM). These methods are described, for example, in Pan Z., Ding D., Wu B., Cuiuri D., Li H., Norrish J. (2018) Arc Welding Processes for Additive Manufacturing: A Review. In: Chen S., Zhang Y., Feng Z. (eds) Transactions on Intelligent Welding Manufacturing. Transactions on Intelligent Welding Manufacturing. Springer, Singapore. https://doi.org/10.1007/978-981-10-5355-9_1]. The production of the substrate plate can further preferably take place by means of multi-wire arc welding and/or in situ alloying, as it is described, for example, in Reisgen et al. 2019, Reisgen, U.; Sharma, R.; Oster, L. Plasma Multiwire Technology with Alternating Wire Feed for Tailor-Made Material Properties in Wire and Arc Additive Manufacturing. Metals 2019, 9, 745. https://doi.org/10.3390/met9070745. An arc is thereby used as heat source in the welding process in order to melt several continuously supplied welding wires (welding filler materials) of identical or different alloys and to convey them into the process zone. If welding filler materials of a different chemical composition are used, they are mixed in the process zone into the desired alloy. A blank for the substrate plate with individually set desired alloy is then produced by means of layered deposition welding. According to the invention, the desired alloy is thereby set so that an Ms temperature (martensite start temperature), which induces a martensitic phase transformation below the manufacturing temperature, is present at least in the region of the component-substrate boundary surface.

Additionally, a consideration of dilution effects by means of partial melting of the substrate plate in the process zone can be advantageous thereby. The dilution A is determined from the percentage by mass of the material of the melted substrate plate (melted substrate material) and of the applied material for the component (substance) according to the formula.

A=percentage by mass of substrate material/(percentage by mass of substance+percentage by mass of substrate material).

An estimation of the martensite start temperature Ms by means of the alloying elements can take place, for example, via the formula according to Steven and Haynes (W. Steven and A. G. Haynes, The temperature of formation of martensit and bainite in low-alloy-steels, Journal of the Iron and Steel Institute, August 1956:349-359, 1956).

$${M}_{s} ( ° C . ) = 561 - 474 * C - 33 * Mn - 17 * Ni - 17 * Cr - 21 * Mo$$

whereby: C=percentage by mass of carbon
Mn=percentage by mass of manganese
Ni=percentage by mass of nickel
Cr=percentage by mass of chrome
Mo=percentage by mass of molybdenum

### Example 1

### Production of the Substrate Plate

The production of a substrate plate for the use in the additive manufacturing according to the invention of a component took place by means of a layered construction of a wall-shaped structure with the help of a cold wire-supported GMAW welding process. Other geometries can advantageously also be created without any problems by means of the WAAM method. A conventional welding device (WB-PS500 L) was used in this case. A GMAW pulse process was set as process modification. A welding filler material of the type EN ISO 14343-A: G 19 9 L Si was used as electrode. As cold wire, a welding filler material of the type EN ISO 16834-A: G 79 4 M Mn4Ni2CrMo was conveyed into the weld pool at a manufacturing temperature T_{F} of 100° C. In the welding-related context, this is also referred to herein as an intermediate layer temperature. This is the temperature, to which the component is cooled down before the next layer is applied. The wire conveying speed of the cold wire was 2 m/min, the speed of the electrode was 8 m/min. The blank manufactured in this way had the dimensions 190×60×5 mm. A machining of the surface to a flat plate with the dimensions 180×50×5 mm took place afterwards. The analysis of the chemical composition of the substrate plate produced in this way took place by means of spark spectroscopic analysis (OES, spark spectrometer Spectro M7, calibrated). The percentages of the composition in Table 1 are specified in percent by mass. The measuring points were distributed over the length of the substrate plate in three clusters. A calculation of the expected martensite start temperature took place on the basis of the OES measurements. This Ms temperature calculated according to Steven and Haynes was between 55° C. and 66° C. According to this, the substrate plate had to be cooled down to approx. −145° C. in order to transform completely martensitically and in order to experience the maximum volume increase. The boiling point of nitrogen is −196° C., liquid nitrogen was thus selected as cooling medium and was used to effect the martensite transformation.

TABLE 1
Averaged results of the OES analysis of
the chemical composition of the substrate

| | | | | | | Ms |
|---|---|---|---|---|---|---|
| C [%] | Mn [%] | Ni[%] | Cr [%] | Mo [%] | Fe [%] | [° C.] |
| 0.0595 | 1.53 | 8.4 | 15.92 | 0.165 | compensation | 65.4 |
| | | | | | to 100% | |

### Construction of the Component

The welding of a wall-shaped structure as component of low-alloy steel (type EN ISO 16834-A: G 79 4 M Mn4Ni2CrMo) took place after the chemical analysis of the substrate plate by means of the same welding device, which was used to produce the substrate plate (WB-P500 L), but by using a low-heat regulated short arc process at a manufacturing temperature T_{F} of 100° C. After the complete construction, no substance separations whatsoever was observed between wall-shaped component (structure) and substrate. The cool-down of the component-substrate plate composite produced in this way took place subsequently by means of complete immersion (quenching) in liquid nitrogen with a holding time of 5 min. After the quenching, a significant substance separation was observed in the boundary region between component and substrate plate, which extends over approx. 25% of the substrate length. It was thus advantageously possible to separate the component from the substrate plate more easily. According to the invention, the substrate plate can additionally advantageously be reused with slight post-processing, for example by means of superficial grinding or milling and can be used in the additive manufacturing of a component.

### Example 2

### Production of the Substrate Plate

The production of a substrate plate for use in the additive manufacturing according to the invention of a component took place by means of a layered construction of a wall-shaped structure with the help of a cold wire-supported GMAW welding process. A conventional welding device (WB-P500L) was likewise used thereby. A GMAW pulse process was set as process modification. A welding filler material of the type DIN 8555: GMAW 7-GF-250-KP was used as electrode. A welding filler material of the type EN ISO 16834-A: G 79 4 M Mn4Ni2CrMo was conveyed into the weld pool as cold wire at a manufacturing temperature T_{F} of 100° C. In contrast to the first example, an alloy concept for the substrate plate was selected on the basis of a manganese-chrome-nickel system. A description of the used alloy concept is reproduced in Diez et al. in Martinez Diez, F. Henry Granjon Prize Competition 2007 Winner, Category B “Materials Behavior and weldability” Development of a Compressive Residual Stress Field Around a Weld Toe by Means of Phase Transformations. Weld World 52, 63-78 (2008).

The wire conveying speed of the cold wire was 4 m/min, the speed of the electrode was 8 m/min. The blank manufactured in this way had the dimensions 210×35×8 mm. A machining of the surfaces to a flat plate with the dimensions 200×31×6 mm took place afterwards. The analysis of the chemical composition of the substrate plate produced in this way took place by means of spark spectroscopic analysis (OES). The 6 measuring points were distributed over the width of the manufactured substrate plate. The averaged results of the spark spectroscopic analysis are reproduced in Table 2 in percent by mass.

TABLE 2
Averaged results of the OES analysis of the chemical
composition of the substrate from Example 2

| | | | | | | Ms |
|---|---|---|---|---|---|---|
| C [%] | Mn [%] | Ni [%] | Cr [%] | Mo [%] | Fe [%] | [° C.] |
| 0.322 | 8.8 | 1.29 | 1.51 | 0.232 | compensation | 65.5 |
| | | | | | to 100% | |

A calculation of the expected martensite start temperatures, which fluctuate due to fluctuations of the chemical composition at the different measuring points on the substrate plate, took place on the basis of the OES measurements. According to Steven and Haynes, manganese as alloy component has an effect on the martensite start temperature, which is approximately twice as strong as chrome and nickel. A martensite start temperature Ms of minimally 36.8° C. was determined for a measuring point according to Steven and Haynes.

### Construction of the Component

The welding of a wall-shaped structure as component of low-alloy steel ((EN ISO 16834-A: G 79 4 M Mn4Ni2CrMo) took place after the chemical analysis of the substrate plate. The further performance as well as the manufacturing parameters corresponded exactly to those from Example 1.

After the quenching in liquid nitrogen as cooling medium, a significant substance separation was observed in the boundary region between component and substrate plate. Several cool-down/heat-up cycles were subsequently run through at room temperature, whereby a progressing crack formation between component and substrate plate was observed, which finally extended over approx. 50% of the substrate length. It was thus advantageously possible to separate the component from the substrate plate more easily. According to the invention, the substrate plate can additionally advantageously be reused with slight post-processing, for example by means of superficial grinding or milling and can be used in the additive manufacturing of a component. The reusability of the substrate plate is an essential advantage, which contributes to the sustainability and to the material and cost savings.

### Example 3

### Production of a Block of Welding Material on Low-Alloy Substrate Plate

The welding filler material from Example 2 (DIN 8555: GMAW 7-GF-250-KP) was used thereby in order to construct a block of welding material with the dimensions 20 mm×20 mm×100 mm. The material was applied to a substrate plate of low-alloy steel of the type S355JR according to DIN 8555: GMAW 7-GF-250-KP. The welding-related processing took plate according to the Examples 1 and 2.

A significant substance separation in the region of the melting line between welding material and substrate took place during the cool-down of the component. According to the benchmark analysis of the welding filler material, the crack formation is attributed to a martensitic phase transformation due to a reduced martensite start temperature.

### BRIEF DESCRIPTION OF THE FIGURES

FIG. 1a-c schematically show steps of a method according to the invention for the additive manufacturing

FIG. 2 schematically shows an arc wire welding process with GMAW welding,

FIG. 3a-b schematically show the manufacturing of a substrate according to the invention,

FIG. 4a shows a photographic image of the substrate from Example 1,

FIG. 4b shows a bar chart with the determined chemical compositions of the substrate from Example 1, assigned to the measuring points marked in FIG. 4a,

FIG. 5 shows the temperature strain curve of the substrate material from Example 1 in a diagram.

FIG. 6 shows the calculated martensite start temperatures for the measuring points from Example 1 in a bar chart

FIG. 7a shows a photographic image of the component-substrate composite from Example 1 after the cool-down

FIG. 7b shows the enlargement of the region X of the component-substrate-composite marked in FIG. 7a

FIG. 8 schematically shows a preferred embodiment with a multi-material substrate.

The invention will be described in more detail below with reference to the figures. It is important to note thereby that different aspects are described, which can each be used individually or in combination. This means that any aspect can be used with different embodiment of the invention, unless explicitly described as pure alternative.

For the sake of convenience, reference will generally always be made only to one entity. Unless noted explicitly, however, the invention can in each case also have several of the entities in question. In this respect, the use of the word “one” is to be understood only as an indication that at least one entity is used in a simple embodiment.

Insofar as methods are described below, the individual steps of a method can be arranged and/or combined in any order, unless specified otherwise by the context. The methods can furthermore be combined with one another—unless explicitly characterized otherwise.

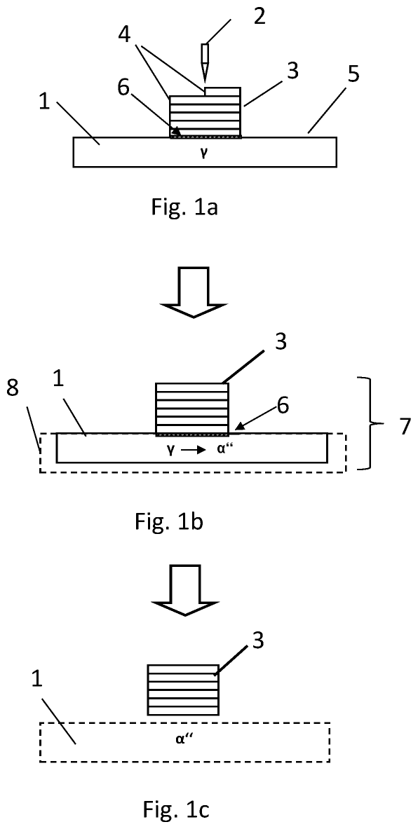

FIGS. 1a-c schematically show a process of a method according to the invention for the additive manufacturing.

In FIG. 1a, a substance for constructing a component 3 in layers 4 (coats) is applied to a provided substrate 1 by means of a print head 2. In the shown embodiment, the substrate 1 is a substrate plate. According to the invention, the substrate 1 is formed from a metallic material. The layered construction (in coats) of the component 3 of the substance takes place at a specified manufacturing temperature T_{F}. At this temperature T_{F}, the material of the substrate 1 is present in a material phase, for example in an austenite phase (γ) with an assigned volume. When applying the first layer 4a of the substance to the construction surface 5 of the substrate 1, the boundary surface 6 to the component 3 is created and thus a component-substrate composite 7. The material of the substrate 1 (substrate material) The substrate 1 according to the invention is formed from a metallic material, which undergoes a martensitic phase transformation below the manufacturing temperature T_{F} and preferably has a martensite start temperature of below 140° C., for example below 100° C., for example of below 70° C. particularly preferably of below 60° C. The substrate 1 can have, for example, a martensite start temperature Ms of approx. 55° C., 50° C., 40° C., 30° C. or 20° C. or of below 20° C., for example 0° C. In an embodiment, which is preferred according to the invention, the metallic substrate material is a low transformation temperature (LTT) alloy.

In FIG. 1b, the created component-substrate composite 7 is cooled down according to the invention in a next step after the complete construction of the component 3 on the substrate plate 1. The cool-down can take place, for example, by immersion into a cooling medium, such as, for example, liquid nitrogen. A phase transformation (γ→α″) of the substrate material from γ towards the martensite phase α″ martensitic phase transformation (martensite transformation) takes place during the cool-down. A volume expansion 8 of the substrate 1 is associated therewith, which is illustrated schematically in the figure by means of the dashed illustration. A compressive stress is induced in the boundary surface 7 by means of the volume expansion 8 of the substrate 1.

The component 3 is separated from the substrate plate in FIG. 1c. At the time of the separation from the component 3, the substrate 1 in the illustrated form is present completely of substrate material in martensite phase α″ with the maximum martensitic volume expansion 8, which, according to the invention, effects at least a partial separation of the component 3 from the substrate 1. In a preferred embodiment of the method according to the invention, the substrate 1 already detaches completely from the component 3 during the cool-down with the martensite transformation and the volume expansion 8 created therewith and the resulting compressive stresses in the boundary surface 6. A complex subtractive removal of the substrate 1 from the component 3 is thus no longer required. This in particular also represents significant time and costs savings in the manufacturing process for an industrial series production. The substrate 1, thus for example a substrate plate, can furthermore be reused, optionally after slight treatment, for example by means of superficial grinding or milling, thus resulting in further options for cost savings.

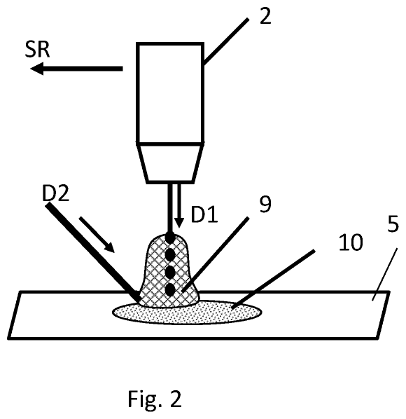

FIG. 2 schematically shows an arc wire welding method, for example GMAW welding, which, in a preferred embodiment, can be used in a method according to the invention, as also illustrated in FIGS. 1a-c. A welding torch 2 is used as print head 2. During the GMAW welding, a consumable electrode D2 is used, which simultaneously also serves as welding filler material. For this purpose, a continuously conveyed wire-shaped welding filler material (welding wire) D1 and the material of the consumable electrode as welding filler material D2, as well as at least partially the construction surface 5 of the substrate plate 1 is melted with the help of a created electric arc 9 as heat source during the GMAW welding. In the effective region of the arc 9 (process zone), the welding filler material D1, supplied as cold wire, and the welding filler material D2 transitions, mostly in drop form, into the resulting weld pool 10 in the substrate plate 1 and form a first welding bead after solidification. By moving the welding torch 2 in the welding direction SR and of the supplied wire D1, any contour material can be applied along a specified path. The process of the layered application is then repeated until the complete construction of the component 3. The GMAW method is usually carried out by using a protective gas in order to prevent an oxidation of the weld pool 10 in the process zone.

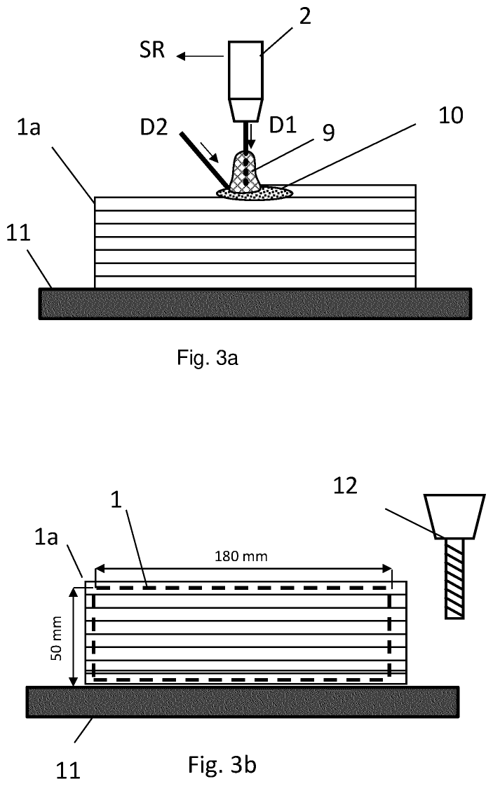

FIGS. 3a and 3b schematically show the manufacturing of a blank 1a of a substrate 1 according to the invention by means of additive manufacturing. An arc wire welding method, as illustrated in FIG. 2, is preferably used for this purpose.

The construction of a blank 1a for a substrate 1 by means of layered application of substrate material on a base 11 is illustrated in FIG. 3a. The manufacturing of the substrate plate 1 according to the invention preferably takes place by means of layered construction of a wall-shaped structure with the help of a cold wire-supported GMAW welding process, as it has been described with regard to FIG. 2. In a further preferred embodiment, several continuously supplied welding wires D (welding filler materials) of identical or different alloys and can be conveyed into the process zone and can be melted. If welding filler materials of a different chemical composition are used, they are mixed in the process zone into the desired alloy. By means of layered deposition welding, a blank 1a is then produced for the substrate plate 1 with individually set desired alloy with the desired martensite start temperature Ms. The Ms temperature (martensite start temperature) is set up so that a martensitic phase transformation below the manufacturing temperature of the downstream construction of a desired component 3 is induced by means of additive manufacturing.

The post-processing of the manufactured substrate blank 1a by a machining of the surfaces to a flat substrate plate 1 (dashed contour) with the dimensions 180×50×5 mm, for example by means of a milling machine 12, is illustrated schematically in FIG. 3b.

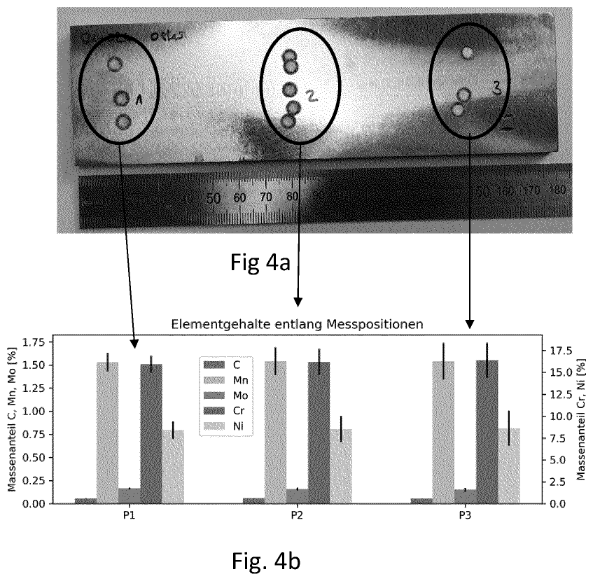

FIG. 4a shows a photographic image of the substrate 1, thus of the manufactured substrate plate 1 from Example 1. Measuring points, at which the chemical composition of the substrate 1 was determined by means of spark spectrometric analysis, are displayed in the image. The marked measuring points are distributed over the length of the substrate plate 1 in three clusters P1, P2 and P3.

FIG. 4b shows a bar chart with the determined chemical compositions of the substrate 1 from Example 1, assigned to the measuring points marked in FIG. 4a. In other words, they represent the results of the spark spectrometric analysis (OES) of the chemical composition of the bar chart assigned in the produced imaged substrate 1 from FIG. 4a. The results of the OES measurements are illustrated in the bar chart as average values of the measuring values in the measuring cluster P1, P2 and P3. The averaged composition of the substrate material has already been specified above in the description of Example 1.

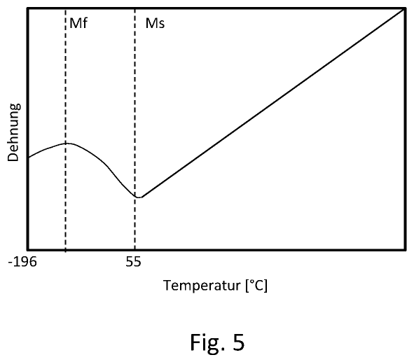

FIG. 5 shows the temperature strain curve of the substrate material from Example 1 in a diagram. In addition to the thermal strain, the jump of the strain curve can be seen at the start of the martensite transformation at Ms=55° C. The substrate material experiences the largest volume expansion 8 during the cool-down at the martensite finish temperature Mf, which lies approximately at −145° C. in the case of the substrate material from Example 1. LTT alloys are characterized in that a shift towards lower temperatures is attained by adapting the alloying elements and composition. Compressive stresses, which counteract the thermal shrinkage stresses (LTT effect), are induced by means of the volume change during the martensite transformation. While this mechanism is used during the joint welding to reduce the residual welding stress in that the alloys are adapted so that the martensite transformation is concluded at room temperature, the martensite transformation and the associated volume expansion 8 is thus used according to the invention to induce compressive stresses in the boundary surface 6 from the substrate 1 to the component 3 applied thereon and to thus provide for an at least significantly simplified separation.

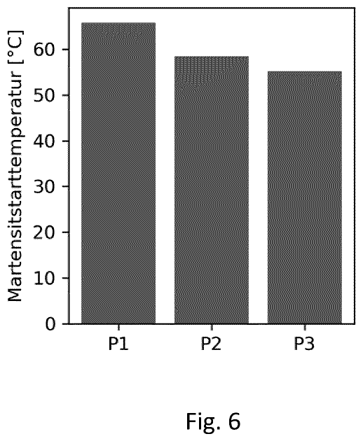

FIG. 6 shows the determined martensite start temperatures Ms for the chemical compositions of the substrate plate 1 from Example 1 determined in the measuring clusters P1, P2 and P3, in a bar chart.

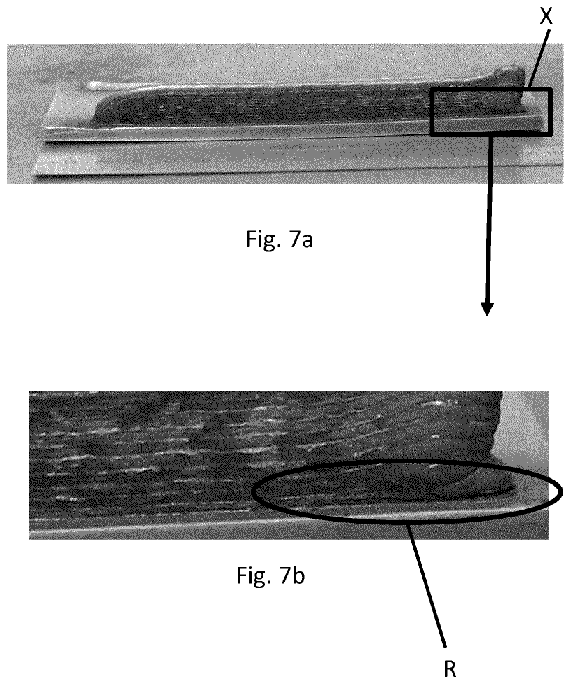

FIG. 7a shows a photographic image of the component-substrate composite 7 from Example 1 after the cool-down in liquid nitrogen with a holding time of 5 minutes. While it was determined prior to the cool-down that no substance separation whatsoever is present between component 3 and substrate 1, a significant substance separation, which extends over approx. 25% of the sample length, was observed in the marked edge region X after quenching the component-substrate composite 7.

FIG. 7b shows the enlargement of the region X of the component-substrate composite 7 marked in FIG. 7a, in which the crack formation and thus the partial separation of the component 3 from the substrate 1 can be seen clearly.

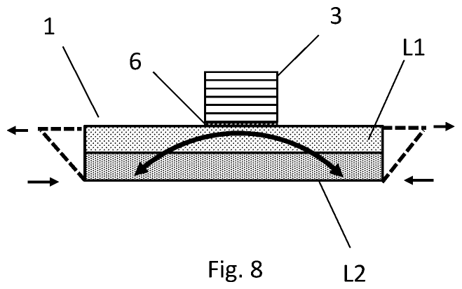

FIG. 8 schematically shows a preferred embodiment with a multi-material substrate. In this preferred embodiment, the substrate 1 is formed from at least two layers L1, L2 of different metallic substrate materials, which are arranged one on top of the other essentially parallel to the construction surface 5, wherein the substrate material of the layer L1 which comprises the construction surface 5 (top side) or which is arranged closer to the construction surface 5, in each case has a higher martensite start temperature Ms than the substrate material of the layer L2 arranged there below. The first layer L1, which comprises the construction surface 5, can have, for example, a martensite start temperature Ms of, for example Ms=20° C. and the layer L2 arranged therebelow, which is further away from the construction surface 5, can have a martensite start temperature Ms of >>0° C. In such a multi-material substrate plate, a preferred direction is provided to the deformation effect during the cool-down, which even further simplifies the separation from the constructed component 3. The preferred directions, which result from the illustrated volume expansion 8 (illustrated in a dashed manner) of the layers L1 and L2, which are pronounced differently at the same temperature, are illustrated schematically with the help of the plotted arrows.

The invention describes the use of the volume expansion effect of a martensitic phase transformation of a substrate, for example in a substrate plate, which is made, for example, of an LTT alloy, in a method for the additive manufacturing of a component for the significantly simplified separation of the component from the substrate. The chemical composition and the construction of the substrate are thereby set so that a martensitic phase transformation below the manufacturing temperature takes place during the additive construction of the component. According to the invention, a component can thus be constructed in layers on the substrate plate according to the invention, and at least the substrate plate can be cooled down to a temperature, which causes the martensite transformation thereof and the associated volume expansion, after the concluded construction of the component. Compressive stresses, which provide for a simplified or even automatic release of the component from the substrate plate, are created in the boundary surface between component and substrate plate by means of the volume expansion of the substrate plate. A complex subtractive removal of the substrate is no longer required. This also represents significant time and cost savings in the manufacturing process in particular also for an industrial series production. The substrate, thus for example a substrate plate, can furthermore be reused after slight post-processing, for example by means of superficial grinding or milling, whereby further options for cost savings result.

### LIST OF REFERENCE NUMERALS

1 substrate (1a blank of the substrate)
2 print head/welding torch
3 component
4 substance layers
5 construction surface of the substrate
6 boundary surface
7 component-substrate composite
8 volume expansion
9 arc
10 weld pool
11 base (substrate plate for the substrate construction)
12 milling machine (tool for machining)
T_{F} manufacturing temperature
Ms martensite start temperature
Mf martensite finish temperature
P1,P2,P3 measuring clusters for the OES analysis
D1 welding filler material (for example cold wire)
D2 welding filler material (for example consumable electrode)
D welding wire/welding filler material
SR welding direction
R edge region with crack formation
L1 material layer
L2 material layer

1. A method for the additive manufacturing of a component (3) at a manufacturing temperature T_{F}, having the steps of
providing at least one substrate (1), in particular a substrate plate, wherein the substrate (1) is formed or will be formed from one or several metallic substrate materials, which is a low transformation temperature (LTT) alloy, wherein the LTT alloy has a martensite start temperature Ms of below 140° C., which is calculated according to the formula
$${M}_{s} ( ° C . ) = 561 - 474 * C - 33 * Mn - 17 * Ni - 17 * Cr - 21 * Mo$$
whereby: C=percentage by mass of carbon
Mn=percentage by mass of manganese
Ni=percentage by mass of nickel
Cr=percentage by mass of chrome
Mo=percentage by mass of molybdenum
by Steven and Haynes and the martensite start temperature Ms lies below the manufacturing temperature T_{F}, and the LTT alloy furthermore is an alloy system on the basis of the main alloying elements iron-chrome-nickel or iron-manganese,
construction of the component (3) on a construction surface (5) of the substrate (1) by layered application of at least one material at a manufacturing temperature T_{F} by forming a component-substrate composite (7) via a boundary surface (6),
cooling down at least the substrate (1) in the component-substrate composite (7) after the complete construction of the component (3) to a temperature below the martensite start temperature Ms, wherein, as a result of a martensite transformation and associated volume expansion of the metallic substrate material, a transformation stress is induced in the substrate (1) at least in the boundary surface (6) to the component (3),
Separating the component (3) from the substrate (1).

2. The method according to claim 1, characterized in that the provision of the substrate (1) comprises a metal wire-based additive manufacturing by means of laser beams, electron beams or arcs, preferably a wire arc additive manufacturing (WAAM).

3. The method according to claim 1, characterized in that the provision of the substrate (1) comprises a WAAM with a multi-wire supply and/or an in situ alloying.

4. The method according to claim 1, characterized in that the substrate material has a martensite start temperature Ms of below 130° C., preferably below 100° C., particularly preferably below 70° C., which is calculated according to the formula by Steven and Haynes.

5. The method according to claim 1, characterized in that the cool-down of the substrate (1) in the component-substrate composite (7) takes place by immersion into a cooling medium.

6. The method according to claim 1, characterized in that the cool-down of the substrate (1) in the component-substrate composite (7) takes place in two or more cool-down/heat-up cycles.

7. The method according to claim 1, characterized in that a separation of the component (3) from the substrate (1) already takes place at least partially with the cool-down.

8. The method according to claim 1, characterized in that the substrate (1) is used in a method for the additive manufacturing again after the separation and a treatment.

9. The method according to claim 1, characterized in that the substrate (1) is formed from an LTT alloy, which undergoes a martensitic phase transformation and has a martensite start temperature Ms of below 100° C., preferably of below 70° C., which is calculated according to the formula by Steven and Haynes.

10. The method according to claim 1, characterized in that the substrate (1) is formed from at least two different metallic substrate materials.

11. The method according to claim 1, characterized in that the substrate is formed from at least two layers (L1, L2) of different metallic substrate material, which are arranged flat one on top of the other essentially parallel to the construction surface (5), wherein the substrate material of the layer (L1), which comprises the construction surface (5) or which is arranged closer to the construction surface (5), in each case has a higher martensite start temperature Ms than the substrate material of the layer (L2) arranged therebelow.

12. The method according to claim 1, characterized in that the substrate has brittle phases, which are formed in the construction surface (5), in the substrate material.

13-15. (canceled)
